(19) United States
(12) Patent Application Publication
(10) Pub. No.: US 2016/0176441 A1
(43) Pub. Date: Jun. 23, 2016

(54) Device for the Enhancement of Vehicle Safety

(71) Applicant: DAIMLER AG, Stuttgart (DE)

(72) Inventors: Reinhard AVERDIEK, Sindelfingen (DE); Joachim FOERNBACHER, Steinheim (DE); Marco HEROK, Hildrizhausen (DE); Tomislav REBIC, Ehningen (DE); Reiner SCHEU, Huelben (DE)

(73) Assignee: Daimler AG, Stuttgart (DE)

(21) Appl. No.: 14/907,125

(22) PCT Filed: Jul. 2, 2014
(86) PCT No.: PCT/EP2014/001818

§ 371 Date: Jan. 22, 2016

(30) Foreign Application Priority Data
Jul. 23, 2013 (DE) 10 2013 012 273.2

(51) Int. Cl. B62D 21/00

(52) U.S. Cl. CPC B62D 21/00

(57) ABSTRACT

A device for the enhancement of vehicle safety of a wheeled vehicle, in particular a passenger vehicle, is disclosed. The device can be connected to a chassis of the wheeled vehicle in such a way that it counteracts screwing in of a wheel in the event of a collision of the wheeled vehicle with an obstacle. An improved passive vehicle safety results if the device is arranged on a wheel carrier of the wheeled vehicle.

### BACKGROUND AND SUMMARY OF THE INVENTION

The present invention relates to a device for the enhancement of vehicle safety of a wheeled vehicle, in particular a passenger vehicle.

As a rule, wheeled vehicles have a steering unit for direction control. A conventional steering unit includes a steering wheel which is connected via a rod-shaped or tubular so-called steering column having steering linkage. Turning the steering wheel against its neutral position, which is familiar to the technician as steering lock, causes at least two wheels of the vehicle mounted on wheel carriers to adopt a certain position by means of chassis geometry, the position causing a change in direction during the operation of the vehicle. The resulting angle between the wheel plane and straight line position is therefore referred to as steering angle in vehicle construction. A torque known as a steering wheel torque or aligning torque, substantially dependent on the speed of the vehicle, acts on the steering column in the opposite direction to the steering angle and thereby ensures a stable straight line of the vehicle in the absence of further steering influences. This phenomenon is familiar to the person skilled in the art as steering return.

In DE 4017210 C1, a torsion bar stabilizer which is connected via link arms to the wheel carrier is proposed to improve the steering return, the stabilizer causing an aligning torque during steering movements of the wheel carrier by means of supports which are provided in a flexible manner on the stabilizer, which in particular can improve the steering return during maximum wheel lock.

However, chassis behavior is problematic in the event of a vehicle accident, which, in the case of passenger vehicles in particular, can release kinetic energies which are dangerous for the vehicle passengers. For the safety of the passengers in such a case, DE 4326668 A1 teaches in its exemplary embodiment according to FIG. 3 and claim 5, the connection of the steering linkage to the bumper of the vehicle, which is on the front in the direction of travel, by means of a specifically arranged lever system. This lever system is configured in such a way that, if a determined impact energy impacting on the bumper is exceeded, it moves the vehicle wheels which were hit in a predetermined direction. The proposed measure ideally ensures that the vehicle tires can serve as a buffer in the event of a collision during cornering of the vehicle in order to achieve distribution of the impact energy which is as extensive as possible and temporally uniform. This damping effect decreases the force with which the vehicle passengers are thrown in the direction of travel in the event of a frontal collision during cornering and thus ultimately reduces their risk of injury.

Despite these measures known from the prior art, there is, however, a specific danger of collision of the vehicle in the event of slight overlapping with the obstacle. In this particular scenario, excessive screwing in of the wheels can result, which leads to the occurrence of deformation of the chassis caused by the collision, the deformation, in the worst case, pressing a wheel at least partially into the passenger compartment. If the integrity of the passenger compartment is destroyed in this manner, there is a threat of the impact of considerable inertial forces on the vehicle passengers, whose health can therefore be at considerable risk.

The present invention thus deals with the problem of specifying an improved embodiment for a device according to type, the embodiment being characterized in particular by an enhanced passive vehicle safety in the event of collisions with slight overlapping.

The invention is based on the general notion of arranging the device directly on a wheel carrier of the wheeled vehicle. Due to this significant constructive simplification, the use of a complex and potentially unreliable lever assembly or a further linkage is unnecessary for connection with vehicle components which are located further away, such as the bumper. The described inertial forces, which can impact on the wheel and wheel carrier in particular in the event of a collision with slight overlapping, can be intercepted in this simple and effective manner by the device.

In one advantageous embodiment, the device can be arranged in such a way that it is able to support the internal structure of the wheel during the collision and the risk of collapse of the wheel which is deformed by impact energy is thereby considerably reduced. Through maintenance of its overall structure, the wheel can divert a large part of the energy to the outer region of the bodywork of the wheeled vehicle in an advantageous manner, where it endangers the integrity of the passenger compartment to a much lesser extent.

According to a preferred development, the device comprises a strut for this purpose, which mechanically reinforces the internal structure due to its shape. The resistance of the internal structure and thereby the whole wheel against an elastic deformation brought about by the impact energy is considerably increased in this embodiment. The design of the device in the form of a strut is therefore provided particularly in view of the exceptionally high load in the event of an accident of the described type.

One embodiment now offers particular advantages, wherein the device, by virtue of its arrangement, restricts screwing in of the wheel in such a way that a predetermined wheel steering angle cannot be exceeded. This restriction ensures that the wheel itself still impinges on the sill during greatest possible screwing in if it is pressed against the bodywork contrary to the direction of travel. The sill, in turn, which is designed for its part in the manner known to the person skilled in the art for the load paths suitable for being received, is able to targetedly dissipate the impact energy diverted onto it and reduce the danger of a penetration.

The device is thereby advantageously arranged in a region of the wheel carrier which, in the direction of travel of the wheeled vehicle, is located on an internal side of the wheel carrier which is facing the opposite end of the axis. Such an arrangement ensures that the device comes into contact with the obstacle before other parts of the wheel carrier in the event of collision, such that it can unfold its supporting effect in an optimum manner at the earliest possible point in time.

For this purpose, it is recommended for production practical considerations to form the device to be already in the wheel carrier at delivery, which leads to further mounting steps for its usual mounting becoming unnecessary. However, in an alternative embodiment, the device may be provided for subsequent mounting on a suitable wheel carrier, which potentially even enables the retrofitting of a wheeled vehicle which is customary in the trade for the enhancement of its passive vehicle safety.

Further important features and advantages of the invention result from the sub-claims, the drawings and the corresponding description of the figures by means of the drawings.

It is understood that the features that are named above and are still to be illustrated below are not only able to be used in the respectively specified combination, but also in other combinations or individually, without exceeding the scope of the present invention.

Preferred exemplary embodiments of the invention are depicted in the drawings and illustrated in greater detail in the description below, wherein the same reference numerals refer to the same or similar or functionally identical components.

### BRIEF DESCRIPTION OF THE DRAWINGS

FIG. 1 is a perspective depiction of a device which is attached to a wheel carrier according to the invention,

FIG. 2 is a partial sectional depiction of a wheeled vehicle which is equipped with the device according to FIG. 1, during its collision with an obstacle,

FIG. 3 is the sectional depiction according to FIG. 2 in a condition shortly after the collision, and

FIG. 4 is the sectional depiction according to FIGS. 2 and 3 in a condition of maximum deformation of the wheeled vehicle.

### DETAILED DESCRIPTION OF THE DRAWINGS

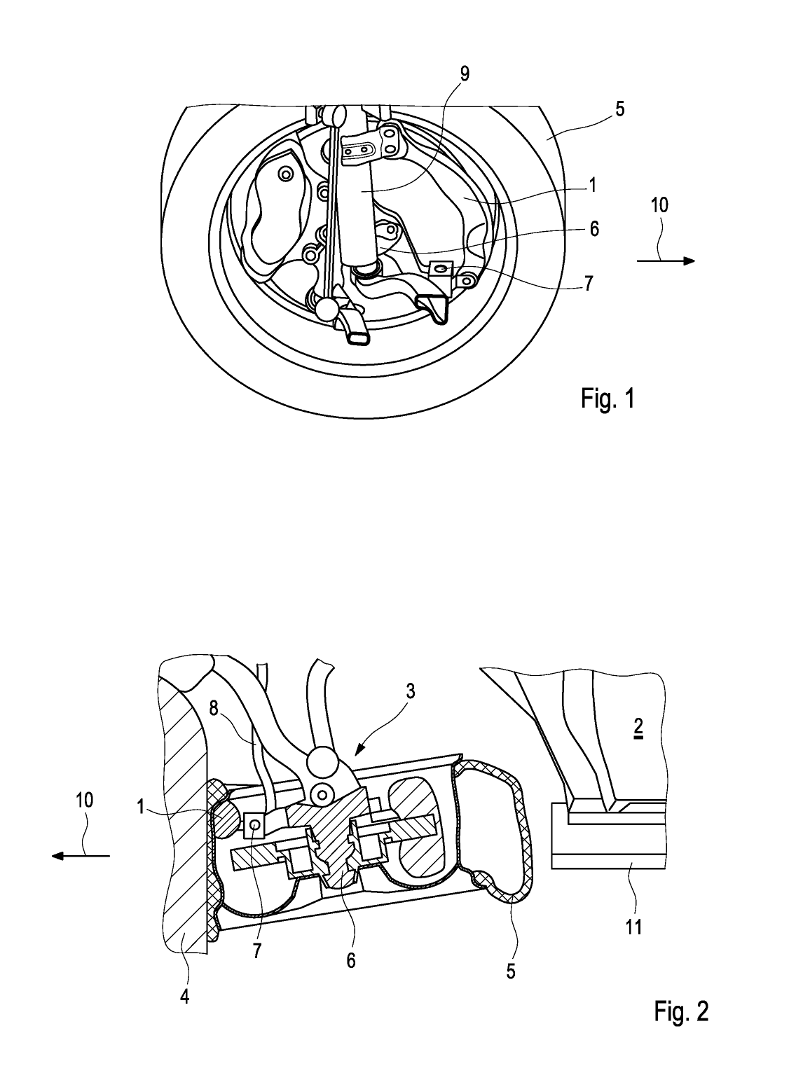

FIG. 1 shows a wheel 5 mounted on a steering knuckle or wheel carrier 6 by means of a wheel bearing, the wheel consisting of a rim which is formed from rolled steel or cast from light metal or forged, having a tire which is profiled in the region of its tread. In FIG. 1, the wheel 5 is thereby depicted from a viewing direction approximately corresponding to the driver position of a correspondingly equipped wheeled vehicle 2 (not shown in FIG. 1) in the mounted condition of the wheel carrier 6, the viewing direction corresponding to the internal side of the wheel 5 in the operation condition. The wheel carrier 6 is provided with independent suspension, which can connect the wheel 5 to a bodywork of the wheeled vehicle 2 via axle guides and a MacPherson spring strut 9 consisting of a spring and a hydraulic shock absorber. A further bodywork connection of the wheel 5 is produced by means of a tie rod 8 which is not depicted in FIG. 1, which attaches to a pivot point 7 of the wheel carrier 6.

The device 1 thereby has the form of a bracket-shaped strut, which goes around the axis of symmetry of the wheel 5 in the form of a circular arc with a central angle of approximately 100° on the internal side of the wheel 5 shown in FIG. 1 in a region which is located in the direction of travel 10 of the wheeled vehicle 2. A bulging thickened deflector plate of the bracket is formed as mechanical strengthening in the event of a collision, approximately at the height of the axis in the wheel center, which further improves the desired support of the wheel 5. In the region of its upper end adjacent to the spring strut 9, the device 1 tapers slightly and has a sufficient clearance, so as not to impair the free running of the tire. In this way, a minimum distance to the wheel and tire is maintained. A corresponding clearance is also provided on the lower end of the device 1 arranged in the region of the pivot point 7 in order to prevent a collision with the brake cover plate by means of a suitable distance in its installed condition. For the purpose of an alternative or additional optimization of distance between the device 1 and brake cover plate, suitable trimming of the contour of the brake cover plate can be undertaken in another embodiment.

On the one hand, an additional intermediate bracket is fastened on the bracket with screw connections, on the other hand on the wheel carrier 6 with a screw connection with the tie rod 8 (not shown in FIG. 1), the screw connection being arranged centrally on the contact surface on the wheel carrier 6 and being orthogonally orientated for the bracket screw connection. The stop surfaces of the wheel carrier 6 corresponding to the intermediate bracket are processed or otherwise adapted in a suitable manner for this purpose. In order to quickly induce a mechanical resting of the bracket on the wheel carrier or steering knuckle in the event of a collision, this is positioned in its nearest point with a slight distance to the wheel carrier or steering knuckle. As regards production, one embodiment of the intermediate bracket is provided as a bending part, for example from a sheet steel. Correspondingly, the pin provided on the wheel carrier 6 for the attachment of the tie rod link is extended by the stated sheet thickness in order to ensure projection of the clamping region provided for the locknut on the pin also in the mounted condition of the tie rod link, such that a secure screw connection between the bracket and the wheel carrier 6 can be established.

In order to prevent the formation of narrow areas in the wiring of the wheeled vehicle 2 equipped according to the invention, the bracket can be provided with a passage, for example for electric cables. A suitable reference distance is also to be complied with here throughout the entire suspension travel and impact of the wheel carrier 6 and requires, if necessary, an inspection on the wheeled vehicle 2 within the scope of end assembly.

With respect to its material, the bracket of the device 1 is produced from aluminum by means of a suitable forging technology, but steel or other composite material can also be used. A screw and a nut are further provided for the connection to the spring strut, and respectively a further screw and nut for fastening on the tie rod screw connection in the region of the pivot point. An alternative, shorter design, in particular of the bracket, may reduce the total mass of the device. Further fastening elements, for example a suitable blank holder or a clamp, can be used for connection to the spring strut fastening screws.

An alternative embodiment which is not shown may be operated instead of the present knuckle steering of another steering technology, or a device according to the invention may be arranged on an unguided vehicle axle. The person skilled in the art further recognizes that the described approach can correspondingly be transferred to the wheel carrier of a driven vehicle axis which may be designed to be unguided or—for example in the case of a four-wheel drive—guided, without leaving the scope of the invention.

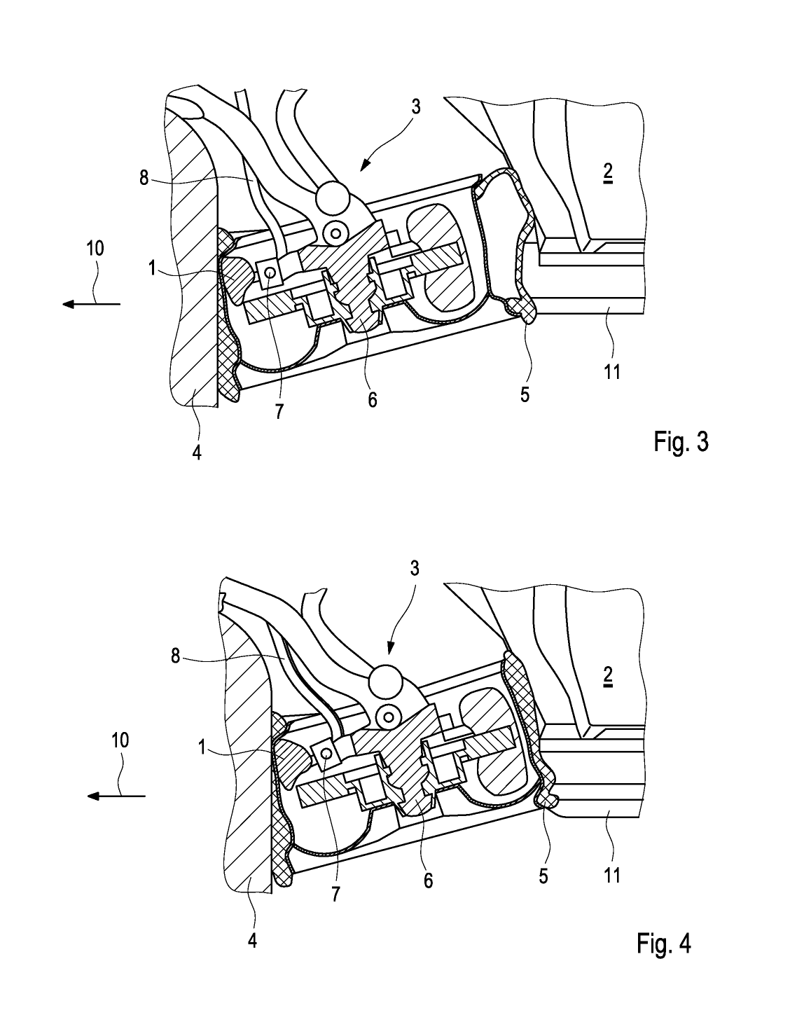

FIGS. 2 to 4 show, in a chronological sequence, different phases of a collision of the wheeled vehicle 2, equipped with a chassis 3 according to the invention, with a fixed obstacle 4 slightly overlapping the left-hand side of the road of the wheeled vehicle 2 in the direction of travel 10. It then becomes clear how the minimal screwing in of the wheel 5 increasingly progresses in the condition shortly after the collision according to FIG. 2, whereby the compressive forces exerted on the contact surfaces of the wheel 5 by the obstacle 4 contrary to the direction of travel 10 shift in the direction of the outer region of the wheel 5. This power shift is in turn accompanied by an increasing torsional moment acting on the steering axle, since the averaged point of origin of the force is further and further away from the pivot point and forms a constantly extending lever arm with this.

The advantageous mode of operation of the invention is disclosed in this scenario, which restricts the screwing in of the wheel to a predetermined maximum angle by means of a jamming, which is already clearly visible in FIG. 2, between a region of the wheel 5, which is elastically deformed by the obstacle 4, and the wheel carrier 6. As a result of this limitation, only a slight power shift results in the sense described above, which in turn is not able to bring about any noteworthy increase of the torque on the steering axle. As a result of these specific kinematics, no intrusion of the wheel 5 in the passenger compartment occurs even in the end condition of the collision according to FIG. 4; instead, the wheel 5 primarily hits the sill 11, where it can targetedly distribute the inertial forces caused by the collision.

1.-9. (canceled)

10. An apparatus for enhancement of vehicle safety of a wheeled vehicle, comprising:
a device which is connectable to a chassis of the wheeled vehicle such that the device counteracts screwing in of a wheel in an event of a collision of the wheeled vehicle with an obstacle, wherein the device is disposed on a wheel carrier of the wheeled vehicle.

11. The apparatus according to claim 10, wherein the device supports an internal structure of the wheel in the event of the collision.

12. The apparatus according to claim 11, wherein the device comprises a strut which mechanically reinforces the internal structure.

13. The apparatus according to claim 10, wherein the device is disposed such that the screwing in of the wheel is limited to a predetermined wheel steering angle.

14. The apparatus according to claim 10, wherein the device is disposed in a region of the wheel carrier which is located internally in a direction of travel.

15. The apparatus according to claim 10, wherein the device is mounted on the wheel carrier.

16. The apparatus according to claim 10, wherein the device is formed in the wheel carrier.

17. The apparatus according to claim 10, wherein the wheel is coupled with a drive of the wheeled vehicle.

18. The apparatus according to claim 10, wherein the wheel is a free-running wheel.
